(19) United States
(12) Patent Application Publication
(10) Pub. No.: US 2026/0111616 A1
(43) Pub. Date: Apr. 23, 2026

(54) METHOD FOR AUTOMATICALLY GENERATING PARAPET IN BIM MODEL

(71) Applicants: Foundation For Research and Business, Seoul National University of Science and Technology, Seoul (KR); COSPEC INNOLAB CO., LTD., Seoul (KR)

(72) Inventors: Bon Sang KOO, Seoul (KR); Young Su YU, Seoul (KR); Si Hyun KIM, Seoul (KR); Won Bok LEE, Seoul (KR); Yoon Jae SUNG, Seoul (KR); Gu Taek KIM, Seoul (KR); Kyung Gon RYU, Seoul (KR)

(73) Assignees: Foundation For Research and Business, Seoul National University of Science and Technology, Seoul (KR); COSPEC INNOLAB CO., LTD., Seoul (KR)

(21) Appl. No.: 19/216,824

(22) Filed: May 23, 2025

(30) Foreign Application Priority Data
Oct. 22, 2024 (KR) 10-2024-0145041

(51) Int. Cl. G06F 30/13; G06F 111/02

(52) U.S. Cl. CPC G06F 30/13; G06F 2111/02

(57) ABSTRACT

A method for automatically generating a parapet in a BIM model is disclosed. A method for automatically generating a parapet according to one embodiment is a method for automatically generating a parapet using a BIM model, the method including: a step of automatically extracting, in the BIM model, a first type parameter value related to geometry information of a wall member for which a parapet is to be generated; a step of receiving, from a user, a second type parameter value for at least one configuration configuring a parapet; and a step of generating a new parapet or updating an existing parapet in the BIM model based on the extracted first type parameter value and the second type parameter value received from the user.

### CROSS-REFERENCE TO RELATED APPLICATION

This application claims priority to and the benefit of Korean Patent Application No. 10-2024-0145041, filed on Oct. 22, 2024, the disclosure of which is incorporated herein by reference in its entirety.

### BACKGROUND

### 1. Technical Field

The present invention relates to a technique for automatically generating or updating a parapet using a building information modeling (BIM).

### 2. Discussion of Related Art

In recent years, the application of a building information modeling (BIM) technology has been expanded in the construction and civil engineering industry, and the efficiency of structure design and construction has been greatly improved.

The BIM is a system that integrates and manages information necessary for the design, construction, and maintenance of a building based on a three-dimensional model, thereby simulating and optimizing various elements of the building.

A parapet installed on a roof of a building or an outermost part of the building is located above an outer wall, and is a structural element that protects against rain and wind and improves aesthetics.

However, the design and installation of parapets require careful design to fit the exterior walls and roof, water-resistant layers, and the like, which may be time-consuming with existing CAD-based design schemes. Utilizing BIM may automate or standardize such parapet generation, thereby preventing design errors and process issues in advance.

In the existing parapet design work, the user has to manually input information such as the location and height of the wall, the location of the water-resistant layer, and the like, which has a problem that the result may vary according to the experience and skill of the operator. In addition, parapet designs require different designs depending on the combination of various components (e.g., surbase, water-resistant layer, protective mortar, etc.), and there is an inconvenience that manual operations should be performed again with each design change.

### SUMMARY

The present invention is a technology for automatically generating or updating a parapet by using a BIM model, thereby minimizing inconveniences and errors that may occur in a process of manually generating a parapet.

In the existing method, a designer has to manually perform a modeling operation in consideration of dimensions or components of a parapet one by one, which is time-consuming and may affect accuracy of a design.

In order to solve this problem, the present invention provides a method for automatically extracting parameters based on geometric information of a wall member in a BIM model, and additionally receiving necessary configuration information from a user to automatically generate a parapet or easily update an existing parapet.

In this way, the present invention aims at maximizing the efficiency of the design and improving the design quality by quickly reflecting various components based on user input.

A method for automatically generating a parapet according to an embodiment is a method for automatically generating a parapet using a BIM model, the method may include: a step of automatically extracting, in the BIM model, a first type parameter value related to geometry information of a wall member for which a parapet is to be generated; a step of receiving, from a user, a second type parameter value for at least one configuration configuring a parapet; and a step of generating a new parapet or updating an existing parapet in the BIM model based on the extracted first type parameter value and the second type parameter value received from the user.

In some embodiments, the step of automatically extracting a first type parameter value may include: a step of generating a virtual solid using a height of a structural wall of the wall member; a step of identifying an outer wall adjacent to the structural wall based on the virtual solid; and a step of extracting a parameter value of the structural wall and the outer wall.

In some embodiments, the step of generating a virtual solid may include: a step of calculating a direction vector of the structural wall of the wall member by using a location curve class when an input for selecting the wall member is received; a step of moving a location curve located at a centerline of the structural wall to an outermost part of the structural wall based on the direction vector; and a step of generating the virtual solid based on the location curve moved to the outermost part and the height of the structural wall.

In some embodiments, the step of receiving a second type parameter value from a user may include: a step of receiving a user input selecting either a first type parapet or a second type parapet; a step of receiving parameters for surbase, water resistance, and protective mortar of the parapet when the first type parapet is chosen; and a step of receiving parameters for surbase, water resistance, protective mortar, a masonry wall, and a water-resistant raised unit of the parapet when the second type parapet is chosen.

In some embodiments, the step of updating an existing parapet may include: removing, when a pre-generated parapet having parameters identical to the first type parameter and the second type parameter is present, a wall sweep included in the pre-generated parapet, and updating the parapet by receiving additional parameters.

According to the present invention, since a parapet may be automatically generated or updated in a BIM model, efficiency and accuracy are greatly improved compared to the existing method of manually designing a parapet.

The present invention may be expected to increase the productivity of BIM-based architectural design and construction and reduce the construction time and cost.

### BRIEF DESCRIPTION OF THE DRAWINGS

FIG. 1 shows a schematic diagram of a parapet generation module according to an embodiment.

FIG. 2 shows a flowchart of an operation of extracting a first type parameter value in an automatic parapet generation module driving process.

FIG. 3 shows a flowchart of an operation of receiving a second type parameter value in an automatic parapet generation module driving process.

FIG. 4 shows a flowchart of a parapet automatic modeling operation using a wall sweep in an automatic parapet generation module driving process.

FIG. 5 shows an example diagram of extracting a first type parameter value.

FIG. 6 shows an example diagram of a first type parapet (type A) and a second type parapet (type B).

FIG. 7 shows an example diagram of a parameter input UI of a first type parapet (type A).

FIG. 8 shows an example diagram of a parameter input UI of a second type parapet (type B).

FIG. 9 shows a schematic diagram of generation of a first type parapet (type A).

FIG. 10 shows a schematic diagram of generation of a second type parapet (type B).

### DETAILED DESCRIPTION

Hereinafter, preferred embodiments of the present invention will be described in detail with reference to the accompanying drawings.

However, the technical idea of the present disclosure is not limited to the described embodiments, but may be implemented in various forms different from each other, and one or more of the components may be selectively combined and replaced between the embodiments within the scope of the present disclosure.

In addition, terms (including technical and scientific terms) used in the embodiments of the present invention may be interpreted as meanings that may be generally understood by those skilled in the art in the technical field to which the present invention belongs, unless clearly and specifically defined and described, and terms that are generally used, such as terms defined in advance, may be interpreted in consideration of their meanings in the context of the related art.

In addition, the terminology used in the embodiments of the present disclosure is for describing the embodiments and is not intended to limit the present disclosure.

As used herein, the singular forms may include the plural forms as well, unless the context clearly indicates otherwise, and may include one or more of any and all combinations that may be combined into A, B, and C when described as “at least one (or one or more) of A, and (as well as) B and C.”

In addition, the terms “first,” “second,” “A,” “B,” “(a),” “(b),” and the like may be used to describe the components of the embodiments of the present invention.

These terms are only used to distinguish the components from other components and the nature, sequence, or order of the components is not limited by the terms.

Furthermore, when an component is described as being “connected,” “coupled,” or “accessed” to another component, it may include not only cases where the component is directly connected, coupled, or accessed to the other component, but also cases where the component is “connected,” “coupled,” or “accessed” by another component between the component and the other component.

In addition, when an component is described as being formed or disposed “on (above) or under (below)” another component, the “on” or “under” includes not only cases where two components are in direct contact with each other, but also cases where one or more other components are formed or disposed between the two components. Furthermore, the expression “on (above) or under (below)” may include not only an upward direction but also a downward direction with respect to one component.

Hereinafter, embodiments will be described in detail with reference to the accompanying drawings, and the same or corresponding components will be denoted by the same reference numerals regardless of the reference numeral, and redundant description thereof will be omitted.

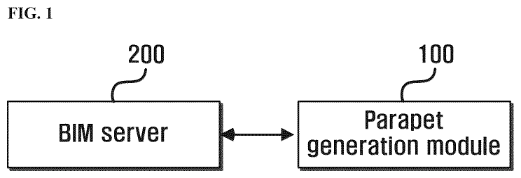

FIG. 1 shows a schematic view of a parapet generation module according to an embodiment.

Referring to FIG. 1, a parapet generation module 100 according to an embodiment of the present invention operates in connection with a BIM server 200. The parapet generation module 100 receives necessary data from the BIM server 200, and performs a function of automatically generating a parapet based thereon.

The BIM server 200 stores and manages various information related to architectural design, and supports the parapet generation module 100 to efficiently extract a first type parameter value (or a first parameter value) required for design, that is, geometric data of a wall, such as a height, a thickness, a length, and a location of the wall. These geometric elements are used as basic data of parapet generation, and the system automatically identifies a location curve, a reference line, and the like of a wall member, and performs parameter extraction based thereon.

Thereafter, a second type parameter value inputted by a user, that is, a detailed specification of a height, a width, a material, a finishing method, and the like of the parapet, is further inputted, and the parapet generation module 100 reflects the values to the generation of a new parapet in a BIM model. This configuration contributes to maintaining data consistency in the design process and improving design productivity through the automated parapet generation process.

The parapet generation module 100 may include at least one command or instruction capable of performing an operation according to an embodiment of the present invention, and may be implemented in a software or hardware manner. Further, integration with the BIM server may facilitate design and review of the overall construction, thereby providing immediate feedback on the location and shape at which the parapet is automatically generated.

According to some embodiments, the parapet generation module 100 may be installed as a centralized server or a cloud server, which is configured separately from the BIM server 200.

In another embodiment, the parapet generation module 100 may be implemented in the form of a software module or control device embedded in a user terminal (e.g., smartphone, laptop, tablet, personal computer, wearable device, etc.).

The parapet generation module 100 may include a processor, a communication unit, a memory, and an input/output interface (e.g., display, touch display, etc.).

The processor may be implemented as hardware, software, or a combination thereof, and may execute control logic, for example, in the form of a microcontroller, a field-programmable gate array (FPGA), or an application-specific integrated circuit (ASIC).

The communication unit may include an interface for transmitting and receiving data to and from the BIM server 200 via a wired or wireless network, and may be used to transmit and receive various types of data associated with the present invention.

The communication unit may support short-range communication, a global navigation satellite system (GNSS) module (e.g., GPS module), optical communication, broadcasting transmission and reception, and intelligent transport system (ITS) communication.

Furthermore, the communication unit may perform long-distance communication with the BIM server 200 and cloud-based interworking by using a mobile communication module such as LTE or 5G and a wireless internet module to enable real-time data reception and synchronization with the cloud.

The memory may serve as a storage device for storing data and programs required for operation of the parapet generation module 100, and may include one or more instructions executed by the processor.

The instructions may include interworking logic configured to: automatically extract a first type of parameter value associated with the geometry of a wall member in the BIM model to which a parapet is to be applied; receive, from the user, a second type of parameter value corresponding to at least one component forming the parapet; and generate a new parapet or update an existing parapet in the BIM model based on the extracted first type of parameter value and the user-input second type of parameter value.

The memory may include non-volatile memory (e.g., hard disk drive, flash memory, EEPROM, SRAM, FRAM, PRAM, MRAM, etc.) and volatile memory (e.g., DRAM, SDRAM, DDR-SDRAM, etc.), and a combination thereof may be used to construct a memory system with various capacities and performance characteristics.

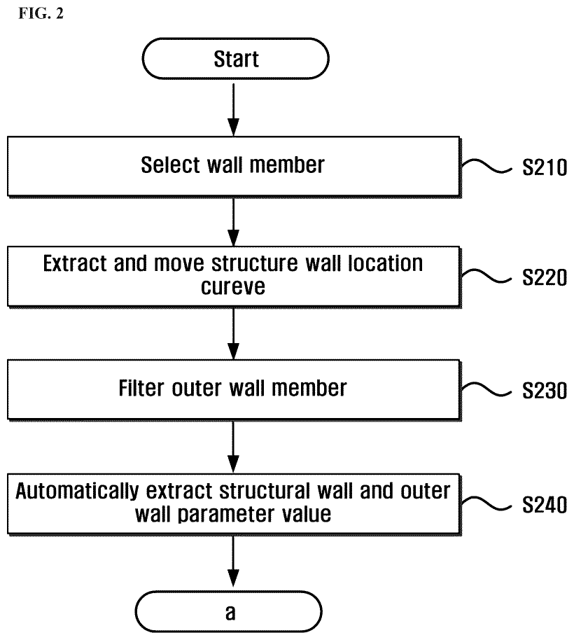

FIG. 2 shows a flowchart of an operation of extracting a first type parameter value in an automatic parapet generation module driving process.

Referring to FIG. 2, a driving process of the automatic parapet generation module according to an embodiment of the present disclosure includes the following steps.

First, in step S210, a user selects a wall member for which a parapet is to be made. For example, a program (e.g., Revit) provided by the BIM server 200 may be executed to display objects including multiple wall members, and a specific wall member may be selected according to user input. At this time, the parapet generation module 100 reviews a family type to confirm whether the selected wall member is a structural wall where a parapet may be generated. The parapet generation module 100 may determine whether the parapet is an installable wall by identifying a family type of the structural wall.

Next, in step S220, the parapet generation module 100 extracts a location curve of the structural wall and moves it.

When an input for selecting the wall member is received, the parapet generation module 100 may calculate a direction vector of the structural wall of the wall member by using a location curve class.

The location curve class in the present invention defines the centerline and geometric elements of the wall within the building information modeling (BIM) model, and serves to determine the location and direction of the wall required for parapet generation. The location curve class tracks a centerline or an outline of the wall, and automatically calculates a location at which the parapet is to be installed according to a geometric arrangement of the wall, so as to provide location data in three-dimensional space. This location curve class may perform at least one of the following operations: extracting the centerline of the wall, calculating the direction vector, moving to the outermost part, extending and combining curves, providing coordinates for the parapet design, and updating the location curves.

For example, a location curve is defined with reference to a centerline of the wall. This curve moves along the center of the wall, and the coordinates of the curve are determined by reflecting the height and width of the structural wall. This location curve is then used to form the outermost part of the wall.

Specifically, the parapet generation module 100 calculates the direction vector of the structural wall to move the location curve by half the width of the structural wall, thereby deriving the outermost part of the structural wall. This step is a procedure that clarifies the geometrical shape of the structural wall and establishes accurate wall boundaries for later parapet generation.

In step S230, the parapet generation module 100 filters an outer wall member. The parapet generation module 100 collects the wall members in the whole BIM model by using the filtering class, and selects and returns only the outer wall member type among the wall members that intersect with a generated solid. This process is necessary to clearly understand the relationship between the structural wall and the outer wall, and serves to analyze the external elements that affect parapet generation.

In the present invention, a filtering class is a technical tool used to efficiently select a wall member required for parapet generation in a BIM model, and to distinguish a structural wall and an outer wall member to extract an accurate parameter value. The filtering class is an algorithm that automatically filters an element that meets specific conditions among wall members, and serves to maximize design efficiency and remove unnecessary data.

Finally, in step S240, the parapet generation module 100 automatically extracts parameter values of the structural wall and the outer wall. These extracted parameter values include various geometrical elements such as distance, angle, and locational relationship between the structural wall and the outer wall, and are utilized as information necessary for a parapet design. The extracted parameter values are automatically passed to the parapet generation module, based on which the parapet is automatically generated or updated in the BIM model.

Through this series of processes, the automatic parapet generation module automates operations from wall member selection to parameter value extraction, thereby increasing design efficiency and improving accuracy and speed of the design process.

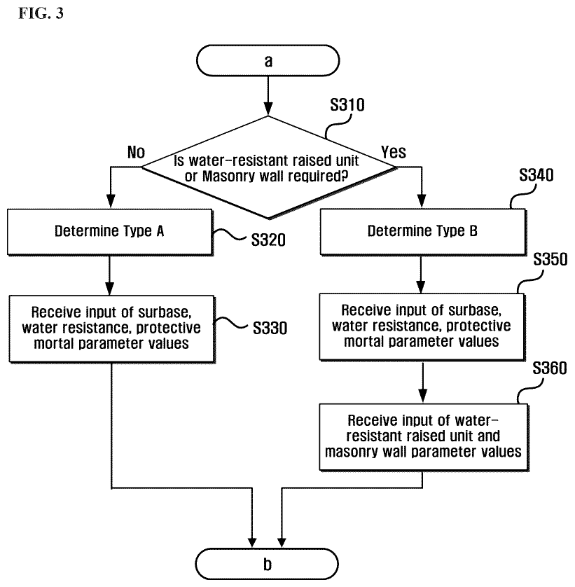

FIG. 3 shows a flowchart of an operation of receiving a second type parameter value (for example, a second parameter value) in an automatic parapet generation module driving process.

Referring to FIG. 3, a driving process of the parapet generation module 100 according to an embodiment of the present disclosure includes the following steps.

First, in step S310, the parapet generation module 100 determines whether a water-resistant raised unit or a masonry wall is required. This determination may be determined by user input. The user reviews whether a water-resistant raised unit or a masonry wall is needed to suit the design environment, and then makes a decision thereon.

When a water-resistant raised unit or a masonry wall is not required, a first type parapet (type A) is determined in step S320. This type of parapet has a relatively simple structure and is mainly focused on basic components such as surbase, water resistance, and protective mortar.

In some cases, the term “surbase” may be used interchangeably with “thickness”, particularly where both represent the dimensional depth of a structural or sub-structural layer. Also, depending on the context, material composition, or environmental conditions, the distinction between “waterproof” and “water-resistant” may not be absolute. As such, the terms may be used interchangeably to describe components that exhibit sufficient resistance to water ingress for the intended application.

In the subsequent step S330, the parapet generation module 100 receives parameter values of surbase, water resistance, and protective mortar. The surbase finishes the top of the parapet and plays a functional and aesthetic role, the water resistance is an element that enhances the structural stability of the parapet, and the protective mortar is responsible for the durability and protective function of the parapet. The user may input the height, material, finishing method, and the like of each of these elements to define the detailed characteristics of the parapet.

On the other hand, when it is determined that a water-resistant raised unit or a masonry wall is necessary, a second type parapet (type B) is determined in step S340. The second type parapet includes additional elements, such as water-resistant raised units and masonry walls, to meet more complex design needs.

In step S350, the parapet generation module 100 receives the parameter values of surbase, water resistance, and protective mortar, and in step S360, the parapet generation module 100 further receives parameter values of a water-resistant raised unit and a masonry wall. The water-resistant raised unit serves to prevent water and moisture from entering between the parapet and the outer wall, and the masonry wall serves to enhance the durability and stability of the parapet. A user may define the size, material, installation method, and the like of each element.

Through this process, a user may select a parapet type that meets design requirements, and automatically generate a parapet by inputting required parameter values. The automated parapet generation process of the present invention helps to quickly and accurately design the parapet within the BIM model, reflecting the user's input.

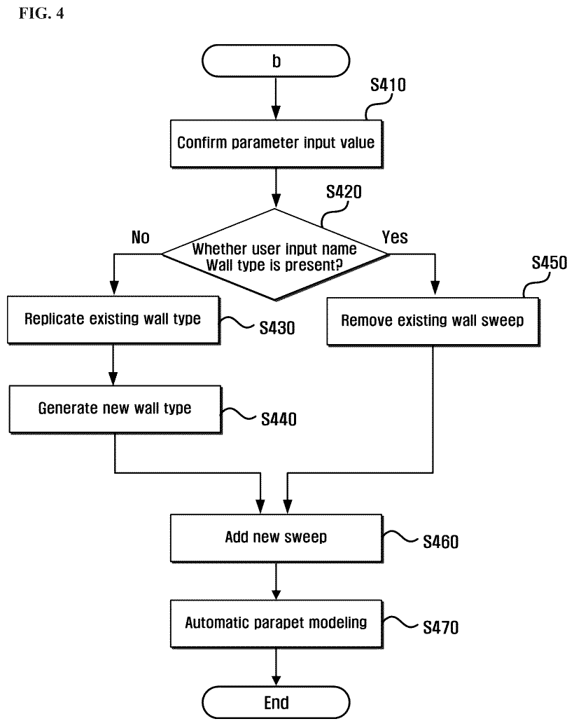

FIG. 4 shows a flowchart of a parapet automatic modeling operation using a wall sweep in an automatic parapet generation module driving process.

Referring to FIG. 4, a driving process of the automatic parapet generation module according to an embodiment of the present disclosure includes the following steps.

First, in step S410, the parapet generation module 100 checks a parameter input value input by a user. Here, the parapet generation module 100 checks whether there is a missing value or an erroneous value in second type parameter values (height, width, material, finishing, etc. of the parapet) input by the user. The step of checking the accuracy of these input values is a procedure that prevents errors in the subsequent automatic modeling process and allows the design to proceed as desired.

Next, in step S420, the parapet generation module 100 checks whether the wall type specified by the user is present in the BIM model. When the wall type is not present, in step S430, the parapet generation module 100 replicates the existing similar wall type to generate a new wall type in step S440. This is a function that allows new design elements to be added according to the user's needs, thereby providing flexibility in design.

On the other hand, when the wall type is already present, in step S450, the parapet generation module 100 removes a sweep of the previously generated wall. The sweep is an element that defines the shape of the parapet generated along the top or outline of the wall, and the process of removing the existing sweep is part of the task of changing the shape of the wall to meet new design requirements.

Thereafter, in step S460, the parapet generation module 100 adds a new sweep. In this step, the shape of the parapet is newly defined according to the input parameter value, and a sweep reflecting this is added to the wall. The sweep is used in the process of automatically modeling the parapet at the top or outline of the wall, and accurately defines the height and shape of the parapet.

Finally, in step S470, automatic parapet modeling is performed to finally generate a parapet. At this time, the parapet is automatically designed in the BIM model on the basis of the previously entered parameter values and the sweep generated for the wall type.

Through this series of processes, a user has the flexibility to add new design elements while maintaining the existing wall type, or to remove existing elements and replace them with new elements as needed. This increases the efficiency of the design process while providing the ability to flexibly adapt to various parapet design needs.

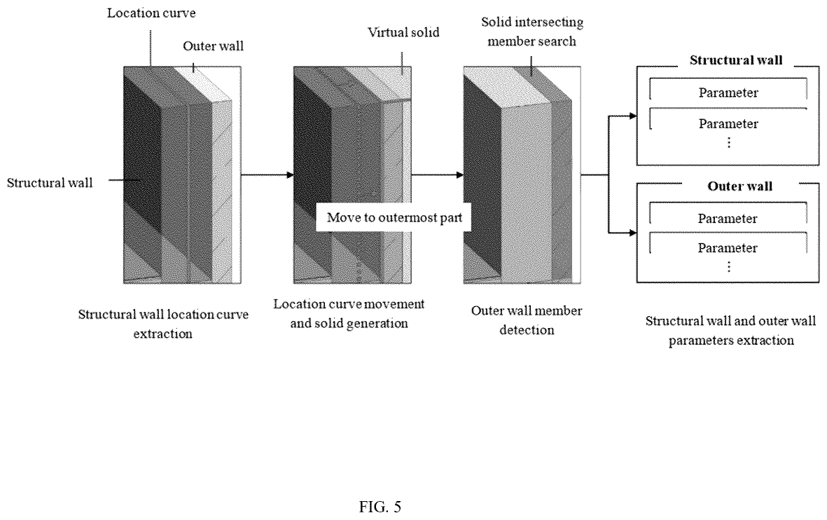

FIG. 5 shows an example diagram of extracting a first type parameter value.

Referring to FIG. 5, a driving process of an automatic parapet generation module according to an embodiment of the present disclosure starts with a step of automatically extracting parameter values of a structural wall and an outer wall.

First, the direction vector (xyz) of the structural wall is calculated by using a location curve (LocationCurve) of the structural wall, and through this, the location curve is moved by half the width of the structural wall to derive the outermost part of the structural wall. This is a process of clearly understanding the actual boundary of the structural wall and then determining where the parapet is to be generated. The movement of the location curve defines the outer line of the structural wall, and this data is used as basic information for parapet generation.

Thereafter, a virtual solid is generated using the moved location curve and the height of the selected structural wall to confirm the intersection with other surrounding elements. This virtual solid visually represents the physical relationship between the structural wall and the outer wall, and forms a three-dimensional model to be referenced in a parameter extraction process.

Specifically, in the present invention, the virtual solid is a three-dimensional shape generated based on geometric characteristics of a wall in a BIM environment. The virtual solid is generated based on geometric parameter values such as height, thickness, length, and location of the wall member, which serves as a structural reference point referenced in parapet generation.

First, when a wall member is selected, a centerline and a direction vector of the wall are extracted. These centerline and direction vector provide the basic coordinate data that determines the location and direction of the wall, on the basis of which the outermost part of the wall may be extracted. The outermost part of the wall then reflects the actual physical boundary of the wall and becomes an important reference for generating a virtual solid.

More specifically, as shown in FIG. 5, the parapet generation module 100 collects the wall members in the entire model by using a filtering (FilteredElementCollector) class, and selects and returns only an outer wall member type among the wall members that intersect with the generated solid, to find the outer wall member that is adjacent to the structural wall. Through this filtering process, the surrounding outer wall members are efficiently identified, and the accuracy of parameter extraction is improved.

Through this process, the parameter values of the selected structural wall and outer wall, that is, information such as width and height, are automatically extracted, and the parapet generation module 100 derives information required for parapet design. These parameter values are utilized as the basic data required for the profile modeling for configuring the parapet, and serve to reflect the physical characteristics and design needs of the parapet.

This automated parameter extraction process allows the designer to accurately perform parapet modeling according to the structural characteristics of the wall and perform fast and consistent design work within the BIM environment.

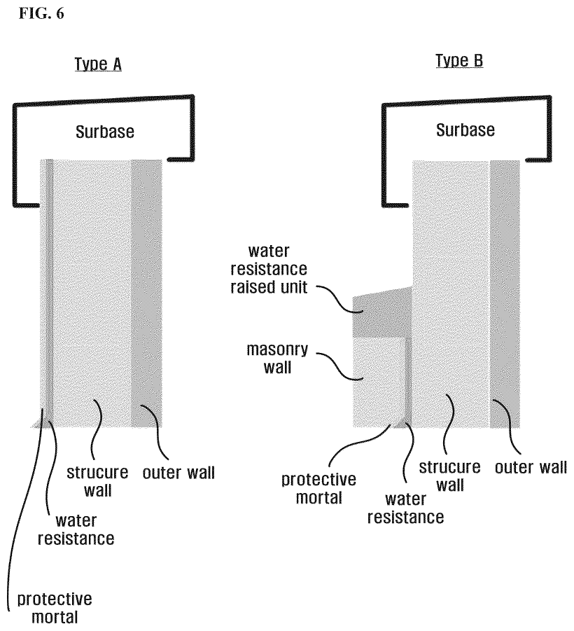

FIG. 6 shows an example diagram of a first type parapet (type A) and a second type parapet (type B).

Referring to FIG. 6, an automatic parapet generation module according to an embodiment of the present disclosure provides two types of parapets.

Type A is composed of surbase, water resistance, and protective mortar, and is mainly used in medium-sized buildings or commercial buildings. This type of parapet focuses on practicality and functionality, and on leak prevention and structural stability rather than appearance. The surbase is an element that covers the top of the parapet, providing both aesthetic completion and functionality of the parapet. Water resistance prevents water from penetrating through the parapet, and protective mortar serves to prevent physical damage and enhance durability of the parapet.

Type B meets more complex structural requirements, with the addition of water-resistant raised units and masonry walls to the basic components of type A. This type of parapet is suitable for high-rise buildings or complex structures and provides enhanced water resistance and structural stability. The water-resistant raised unit is an additional device that prevents water ingress from the outside, and play a particularly important role in high-rise structures. The masonry wall reinforces the foundation structure of the parapet to improve the overall stability and enhance the durability of the parapet.

Each parapet type is designed in consideration of the thickness and height of the structural wall and the outer wall of the building, and a user may input the parameters of each profile through the module UI to increase the flexibility of the design. This configuration allows a user to select and design a parapet that meets the requirements of a particular building, and input parameters to apply the automatically generated parapet within the BIM model.

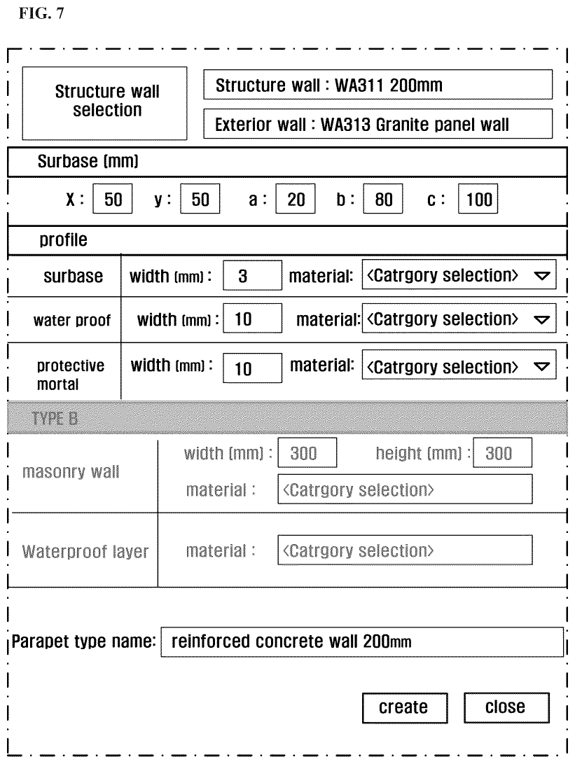

FIG. 7 shows an example diagram of a parameter input UI of a first type parapet (type A).

Referring to FIG. 7, a parameter input UI of an automatic parapet generation module according to an embodiment of the present disclosure provides an interface for inputting detailed parameters for profiles such as surbase, water resistance, protective mortar, and the like. A user may input parameters such as thickness, width, height of surbase, and select the material of each profile.

For example, the parameter of surbase, consisting of x, y, a, b, and c, is used to define the geometric property of the surbase. For example, the thickness of surbase, defined as x, and y, is an element for ensuring the structural stability of the surbase. In addition, the functionality of the parapet may be enhanced by inputting the width and material of the water resistance and protective mortar.

This UI allows a user to finely adjust the parapet to the design requirements and increases the flexibility of the design. In this way, the user may adjust the thickness of the water-resistant layer or change the material of the protective mortar according to a specific environment or condition, so as to automatically implement a more efficient and customized design.

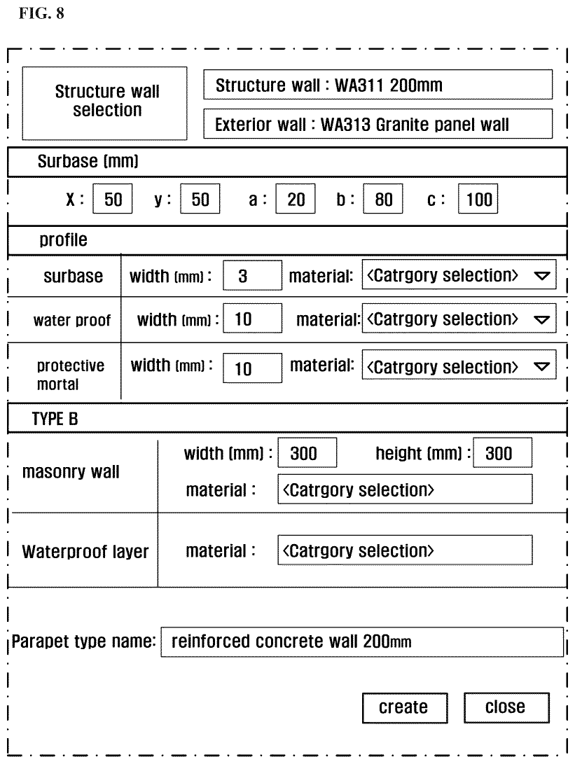

FIG. 8 shows an example diagram of a parameter input UI of a second type parapet (type B).

Referring to FIG. 8, a parameter input UI of an automatic parapet generation module according to an embodiment of the present invention is shown. This UI is configured to allow a user to select the parapet type B and input detailed parameters of each profile.

The UI includes an input field for inputting the width and material for each profile of surbase, water resistance, protective mortar, a water-resistant raised unit, and a masonry wall. For example, the width of the surbase may be set to 100 mm, the width of water resistance may be set to 80 mm, and the width of protective mortar may be set to 20 mm. In addition, the height of the masonry wall is inputted as 300 mm, and the interval between the water-resistant raised units may also be set.

At the bottom of FIG. 8, a cross-section of the parapet is shown, where the location and size of each profile is visually represented. It is composed of surbase, water resistance, protective mortar, a water-resistant raised unit, and a masonry wall in this order, and the thickness and location of each profile are indicated. Through this UI, the user may finely adjust the parapet according to the design requirement, and the input parameter values are utilized in a later automatic parapet generation process.

Through this parameter input process, a user may increase the flexibility of the design and automatically implement a more efficient and customized parapet design.

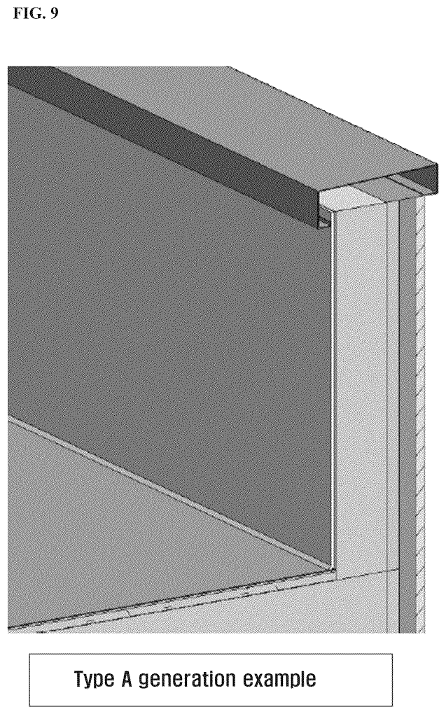

FIG. 9 shows a schematic diagram of generation of a first type parapet (type A).

Referring to FIG. 9, a parapet of type A generated through an automatic parapet generation module according to an embodiment of the present invention is shown. Type A is a basic parapet type consisting of surbase, water resistance, and protective mortar, and is designed to enhance water-resistant and protective functions. As may be seen in FIG. 9, the top of the parapet has surbase, below which the water-resistant layer and the protective mortar are arranged one after the other. Such a configuration is mainly used in a medium-sized building or a commercial building, and is suitable for a building in which functionality is more important than appearance.

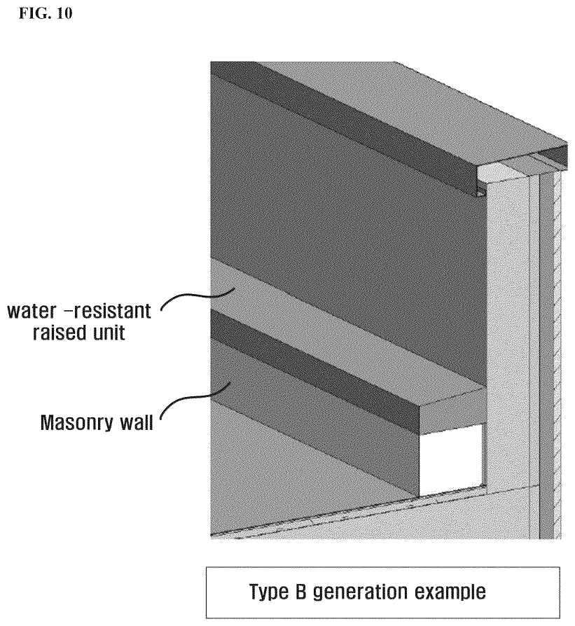

FIG. 10 shows a schematic diagram of generation of a second type parapet (type B).

Referring to FIG. 10, a Type B generation example of an automatic parapet generation module according to an embodiment of the present invention is shown. Type B is suitable for high-rise buildings or complex structures in a form that includes a masonry wall and a water-resistant raised unit to enhance structural stability and water-resistant function.

As shown in FIG. 10, the water-resistant raised unit is located at the top of the parapet and serves to prevent moisture penetration from the outside, and the masonry wall is located at the bottom of the parapet to provide structural support and stability. These components may be finely adjusted through each parameter value, and a user may input the width, height, and material of each profile through the module UI to generate a parapet tailored to the design requirements.

Such an automated parapet generation manner contributes to maintaining consistency in design change, improving design quality, and increasing work efficiency.

The term “unit” used in this embodiment refers to software or hardware components such as a field-programmable gate array (FPGA) or an ASIC, and the “unit” performs certain roles. However, the term “unit” is not limited to software or hardware. The “unit” may be configured to be in an addressable storage medium or may be configured to reproduce one or more processors. Thus, by way of example, the “unit” includes components such as software components, object-oriented software components, class components, and task components, as well as processes, functions, attributes, procedures, subroutines, segments of program code, drivers, firmware, microcode, circuitry, data, databases, data structures, tables, arrays, and variables. Functionality provided within components and “units” may be combined into a smaller number of components and “units” or further separated into additional components and “units.” Further, the components and “units” may be implemented to play one or more CPUs in a device or secure multimedia card.

Although the foregoing has been described with reference to the preferred embodiments of the present invention, it will be understood by those skilled in the art that various modifications and changes may be made to the present invention without departing from the spirit and scope of the invention as set forth in the following claims.

What is claimed is:

1. A method for automatically generating a parapet using a building information modeling (BIM) model, the method comprising:
a step of automatically extracting, in the BIM model, a first type parameter value related to geometry information of a wall member for which a parapet is to be generated;
a step of receiving, from a user, a second type parameter value for at least one configuration configuring a parapet; and
a step of generating a new parapet or updating an existing parapet in the BIM model based on the extracted first type parameter value and the second type parameter value received from the user.

2. The method of claim 1,
wherein the step of automatically extracting a first type parameter value includes:
a step of generating a virtual solid using a height of a structural wall of the wall member;
a step of identifying an outer wall adjacent to the structural wall based on the virtual solid; and
a step of extracting a parameter value of the structural wall and the outer wall.

3. The method of claim 2,
wherein the step of generating a virtual solid includes:
a step of calculating a direction vector of the structural wall of the wall member by using a location curve class when an input for selecting the wall member is received;
a step of moving a location curve located at a centerline of the structural wall to an outermost part of the structural wall based on the direction vector; and
a step of generating the virtual solid based on the location curve moved to the outermost part and the height of the structural wall.

4. The method of claim 1,
wherein the step of receiving a second type parameter value from a user includes:
a step of receiving a user input selecting either a first type parapet or a second type parapet;
a step of receiving parameters for surbase, water resistance, and protective mortar of the parapet when the first type parapet is chosen; and
a step of receiving parameters for surbase, water resistance, protective mortar, a masonry wall, and a water-resistant raised unit of the parapet when the second type parapet is chosen.

5. The method of claim 1,
wherein the step of updating an existing parapet comprises:
a step of removing, when a pre-generated parapet having parameters identical to the first type parameter and the second type parameter is present, a wall sweep included in the pre-generated parapet; and
a step of updating the parapet by receiving additional parameters.
